(19) United States
(12) Patent Application Publication
(10) Pub. No.: US 2011/0144858 A1
(43) Pub. Date: Jun. 16, 2011

(54) VEHICLE GATEWAY, AND APPARATUS AND METHOD FOR VEHICLE NETWORK INTERFACE

(76) Inventors: Hyun Jeong Yun, Daejeon (KR); So Yeon Lee, Daejeon (KR); Dong Yong Kwak, Daejeon (KR); Jong Hyun Park, Daejeeon (KR)

(21) Appl. No.: 13/058,102

(22) PCT Filed: Oct. 17, 2008
(86) PCT No.: PCT/KR2008/006142

§ 371 Date: Feb. 8, 2011

(30) Foreign Application Priority Data
Aug. 22, 2008 (KR) 10-2008-0082321

(51) Int. Cl. H04W 40/00; G06F 7/00; H04W 36/00

(52) U.S. Cl. 701/33; 370/328; 370/331

(57) ABSTRACT

Provide are a vehicle gateway, and an apparatus and a method for vehicle network interface. The vehicle gateway includes a first interface connected to each unit of a vehicle network, a second interface connected to one or more access devices acquiring vehicle information from the vehicle network, and a packet processor connecting the first interface to the second interface, and determining a communication system and a communication path to each of the access devices and a process order of the vehicle information acquisition.

### TECHNICAL FIELD

The present disclosure relates to a vehicle gateway, and an apparatus and a method for vehicle network interface, and in particular, to a vehicle gateway, and an apparatus and a method for vehicle network interface, which are capable of communicating with a vehicle network.

This work was supported by the IT R&D program of MIC/IITA [2008-P1-17-07K80, Device and method for Seamless Connection between ICT device and Automotive Vehicle Buses]

### BACKGROUND ART

Generally, a Vehicle Control Interface (VCI) can be mounted in a vehicle to support communication between a vehicle network and various Information Communication Technology (ICT) devices such as a vehicle diagnosis device, a Personal Digital Assistant(PDA) and a notebook computer. Herein, the VCI includes a communication protocol such as Controller Area Network (CAN) (ISO 1158), Universal Asynchronous Receiver/Transmitter (UART) and Society of Automotive Engineers (SAE) J1850, and can be connected to an Electronic Control Unit (ECU) constituting the vehicle network via a state machine and a Media Access Controller (MAC) according to each communication protocol. The VCI may be included in a vehicle gateway.

The related art of vehicle gateway is directly connected to the ICT device through wired/wireless, or is connected to the ICT device in a P2P system through the Ethernet, a switch, a Wireless Local Area Network (WLAN) and an Access Point (AP).

In recent, with the advent of various wireless communication systems such as Universal Mobile Telecommunications System (UMTS), Code Division Multiple Access (CDMA), Wireless Broadband (WiBro) (a sort of Mobile WiMAX), WLAN and Wireless Personal Area Network (WPAN), the demand for interconnecting in-vehicle network and various radio access network has been increased to support vehicle information based integrated services.

For this, a technology for the interworking of various wireless communication systems is required, and a technology for the interworking between different providers is also required. However, there exist only a direct connection system and the P2P system as the existing supportable interworking system.

### DISCLOSURE

### Technical Problem

Accordingly, the present disclosure provides a vehicle gateway, and an apparatus and a method for vehicle network interface, which enable the exchange of ECU data between various access devices and a vehicle network.

The present disclosure also provides a vehicle gateway, and an apparatus and a method for vehicle network interface, which support handover between heterogeneous networks to each access device, thereby providing quasi seamless communication.

### Technical Solution

According to an aspect, there is provided a vehicle gateway including: a first interface connected to each unit of a vehicle network; a second interface connected to one or more access devices acquiring vehicle information from the vehicle network; and a packet processor connecting the first interface to the second interface, and determining a communication system and a communication path to each of the access devices and a process order of the vehicle information acquisition.

According to another aspect, there is provided an apparatus for vehicle network interface including; a vehicle network; one or more access devices using at least one of wire communication system and wireless communication system, and accessing the vehicle network to request vehicle information and to acquire the vehicle information; and a vehicle gateway determining a communication system and a communication path among the one or more access devices and the vehicle network and an order of the vehicle information request and an order of the vehicle information acquisition.

According to another aspect, there is provided a method for vehicle network interface for connecting a vehicle network to one or more access devices performing wire communication and wireless communication, the method for vehicle network interface including: receiving vehicle information request from each of the access devices; changing the vehicle information request into a message for the vehicle network; extracting vehicle information corresponding to the message from the vehicle network to change the extracted vehicle information into a response for the each access device; and transmitting the response to each access device receiving the vehicle information request.

### Advantageous Effects

Embodiments of the present invention support stable communication between various access devices and a vehicle network through handover, and extracts and acquires reliable vehicle information from a vehicle network, thereby using the acquired vehicle information in various services such as an intelligent transportation systems(ITS) service, an emergency rescue service, a traffic control service, a transportation safety service and an insurance service.

Embodiments of the present invention provide an efficient way of extracting reliable vehicle information from various kinds of access devices and seamless radio connectivity through handover functionality under the heterogeneous radio access network environments. Thereby, the advanced Telematics and ITS services guarantying the connectivity to service center, road infrastructure and ICT devices can be deployed using the present invention.

### DESCRIPTION OF DRAWINGS

FIG. 1 is a block diagram of an apparatus for vehicle network interface an embodiment of the present invention.

FIG. 2 is a block diagram of a vehicle gateway according to an embodiment of the present invention.

FIG. 3 is a block diagram of a VCI according to an embodiment of the present invention.

FIG. 4 is a flowchart illustrating a method for vehicle network interface according to an embodiment of the present invention.

### BEST MODE

Hereinafter, specific embodiments will be described in detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

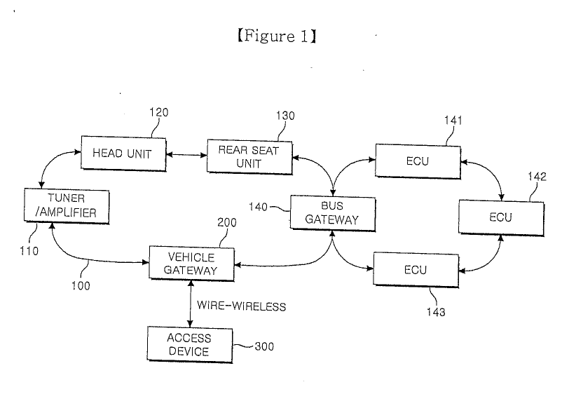

FIG. 1 is a block diagram of an apparatus for vehicle network interface an embodiment of the present invention.

Referring to FIG. 1, the apparatus for vehicle network interface according to the present invention accesses each of units 110, 120, 130, 141, 142 and 143 in a vehicle network 100, extracts vehicle information, checks peripheral traffic situations to a vehicle using the vehicle information, and supports a service for diagnosing whether a failure occurs in a vehicle and a service for preventing troubles of a vehicle. The apparatus for vehicle network interface includes an access device 300, a vehicle network 100, and a vehicle gateway 200. The access device 300 is illustrated as a single element in FIG. 1, but the access device 300 may substantially include a plurality of access devices (not shown).

The access device 300 requests desired vehicle information to each of the units 110, 120, 130, 141, 142 and 143 in a vehicle network 100 to acquire corresponding vehicle information. The access device 300 includes at least one of a nomadic device used in a vehicle, a PDA, a notebook computer, a smart phone, a telematics terminal, a roadside device disposed in the outside of a vehicle, a vehicle diagnosis device, etc. Herein, the vehicle information includes at least one of a vehicle speed, a fuel level and a vehicle location being information related to the monitoring of the vehicle.

The vehicle network 100 is a network connected to the units 110, 120, 130, 141, 142 and 143 being in charge of each function of a vehicle using various buses. That is, the vehicle network 100 includes at least one bus of CAN, Media Oriented Systems Transport (MOST), Local Interconnect Network (LIN), SAE J1850 and FlexRay.

Herein, each unit in the vehicle network 100 includes a head unit 120, a rear seat unit 130, a tuner/amplifier 110, and Electric Control Units (ECUs) 141, 142 and 143. The ECUs 141, 142 and 143 control the power train, chassis, doors, etc of the vehicle. For convenience to control and interface, The ECUs 141, 142 and 143 may be connected to the vehicle network 100 through a bus gateway 140.

The vehicle gateway 200 connects the access device 300 to the vehicle network 100 to thereby support sending and transferring of data for the request and acquisition of vehicle information. Specifically, the vehicle gateway 200 transfers a vehicle information request received from the access device 300 to a corresponding unit in the vehicle network 100, and transfers corresponding vehicle information extracted from the corresponding unit in the vehicle network 100 to the access device 300. Herein, the vehicle gateway 200 may support handover between heterogeneous networks using media independent handover (MIH) to the access device 300.

For example, assuming that a roadside device for monitoring and diagnosing vehicle states in a WiBro communication system and a CDMA communication system is used as the access device 300, the vehicle gateway 200 monitors a communication state with the access device 300 before transmitting vehicle information and changes the communication system of a roadside device using a WiBro communication system of poor communication quality into the CDMA communication system, thereby increasing communication quality to the access device 300. For another example, in a case where an A area collects vehicle information over a Dedicated Short Range Communication (DSRC) network and a B area collects vehicle information over a WLAN network, a terminal mounted in a vehicle moving from the A area to the B area can continuously receive a service via handover between heterogeneous networks without changing a network interface.

In FIG. 1, a case where the units 110, 120, 130, 141, 142 and 143 in the vehicle network 100 are connected in a ring structure to communicate using a ring topology has been described as an example. However, the vehicle network 100 connects the units 110, 120, 130, 141, 142 and 143 in various structures such as a star structure, a bus structure and a tree structure, thereby enabling them to communicate using various topologies.

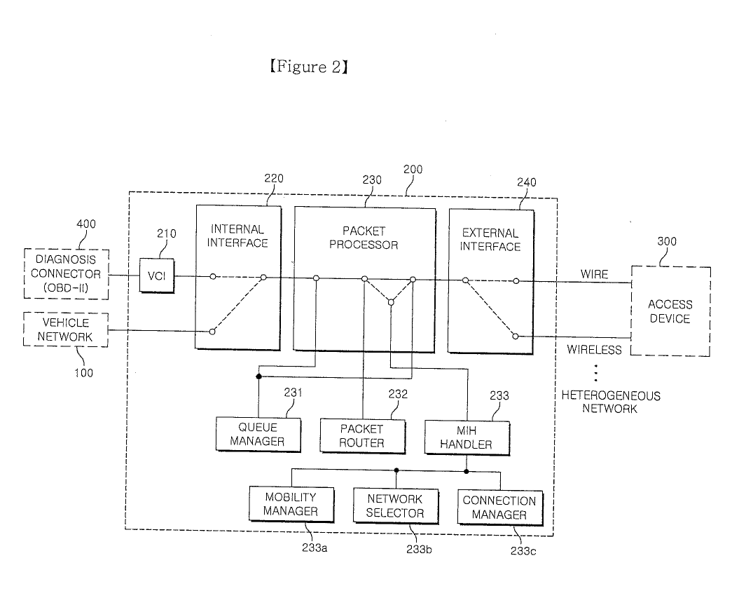

Hereinafter, the detail configuration and function of the vehicle gateway 200 will be described with reference to FIG. 2. FIG. 2 is a block diagram of the vehicle gateway 200 according to an embodiment of the present invention.

Referring to FIG. 2, the vehicle gateway 200 according to an embodiment of the present invention determines a communication system, a communication path and a process order, and provides support for the access device 300 to smoothly communicate with the vehicle network 100 via handover between heterogeneous networks. The vehicle gateway 200 includes an internal interface 220, an external interface 240, and a packet processor 230.

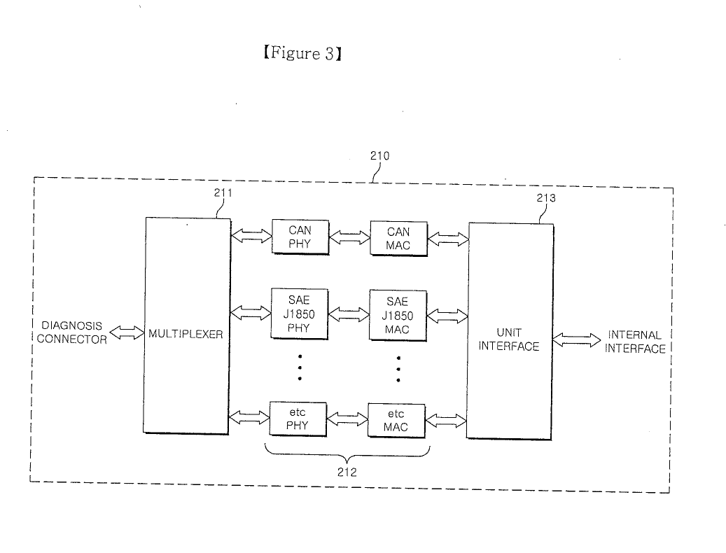

The internal interface 220 provides each interface path for the units 110, 120, 130, 141, 142 and 143 in the vehicle network 100, and provides an interface which is directly connected to a bus of each of the units 110, 120, 130, 141, 142 and 143 or is connected to a vehicle diagnosis device through a diagnosis connector 400. Herein, the vehicle diagnosis device may be on-board diagnostics (OBD-II) for diagnosing the inside trouble of the vehicle. The vehicle gateway 200 further includes a Vehicle Communication Interface (VCI) 210 which connects the internal interface 220 to the diagnosis connector 400 and selectively connects the diagnosis connector 400 to the units 110, 120, 130, 141,142 and 143 connected over the vehicle network 100. The detail function and configuration of the VCI 210 will be described with reference to FIG. 3.

The external interface 240 accesses the vehicle network 100 and provides a connection path with at least one of access device acquiring and requesting of vehicle information. At this point, the external interface 240 may individually provide each path for the access device 300 performing wireless communication and the access device performing wire communication.

For example, a wireless communication system may be WLAN, AP, UMTS, CDMA, WiBro (a sort of Mobile WiMAX), WPAN, wireless access vehicle environment (WAVE), and DSRC. A wire communication system may be a serial communication system such as, Universal Serial Bus (USB) and Inter-Integrated Circuit (12C) and an Ethernet communication system such as IEEE 1394.

The packet processor 230 determines the process order of vehicle information request and vehicle information acquisition, and a communication system and a communication path with at least one access device 300. The packet processor 230 includes a queue manager 231, a packet router 232, and a MIH handler 233. Hereinafter, each element of the packet processor 230 will be described below.

The queue manager 231 sets the process order of vehicle information request and the process order of vehicle information acquisition to the each access device 300. For example, when a car repair shop transmits vehicle information request (A) to the vehicle gateway 200 through an access device and an insurance provider transmits vehicle information request (B) to the vehicle gateway 200 via an access device, the vehicle gateway 200 can first process the first received vehicle information request of the vehicle information request (A) and the vehicle information request (B) according to internal settings. At this point, the queue manager 231 may schedule the process order according to the queue architecture.

The packet router 232 allocates a communication path for the access device 300 and each of the units 110, 120, 130, 141, 142 and 143 in the vehicle network 100.

The MIH handler 233 supports MIH being a framework and handover between heterogeneous networks standardized by IEEE802.21 working group. The MIH handler 233 includes a connection manager 233c, a mobility manager 233a, and a network selector 233b.

The connection manager 233c sets connection for an application layer, a device driver layer and a physical layer.

The mobility manager 233a and the network selector 233b are in charge of a MIH event service, a MIH command service, a MIH information service, etc. Hereinafter, such services will be described below.

The MIH event service is that the mobility manager 233a receives information about states of the device driver layer. The MIH event service includes a link event for receiving the state information of the physical layer and link layer of specific network, and a MIH event for compiling and receiving the link events of a heterogeneous network.

The MIH command service is that the mobility manager 233a changes an application layer and a network access state or queries a network state.

The MIH information service is to provide information (e.g., data rate, network identification (ID), roaming partner, security, Quality of Service (QoS)) of a heterogeneous network adjacent to the apparatus for vehicle network interface.

Hereinafter, the VCI 210, which is disposed between the internal interface 220 and the diagnosis connector 400 to provide an interface between them, will be described below. FIG. 3 is a block diagram of the VCI 210 according to an embodiment of the present invention.

Referring to FIG. 3, the VCI 210 according to an embodiment of the present invention provides an interface between the internal interface 220 and the diagnosis connector 400. The VCI 210 includes a unit interface 213, a plurality of converters 212, and a multiplexer 211.

The unit interface 213 provides a path connected to each of the units 110, 120, 130, 141, 142 and 143 in the vehicle network 100 through the internal interface 220.

The number of the converters 212 may be equal to the number of kinds of buses of the units 110, 120, 130, 141, 142 and 143 or the number of kinds of protocols. The converters 212 convert a signal transmitted to the diagnosis connector 400 or each of the units 110, 120, 130, 141, 142 and 143 into a format recognizable by a device (e.g., OBD-II device) connected to the diagnosis connector 400 or by each of the units 110, 120, 130, 141, 142 and 143 in the vehicle network 100.

For example, in a case where the units 110, 120, 130, 141, 142 and 143 in the vehicle network 100 use a CAN bus and a SAE J1850 bus, the converters 212 may include a converter (A′) to a unit using the CAN bus and a converter (B′) to a unit using the SAE J1850 bus. If the cost and the area are not excessive, the converters 212 may be configured to support a change for as many kinds of buses as possible.

The multiplexer 211 selectively provides paths from each of the converters 212 to the diagnosis connector 400. In other words, the multiplexer 211 selectively connects the diagnosis connector 400 to each of the units 110, 120, 130, 141, 142 and 143 in the vehicle network 100. At this point, the multiplexer 211 further includes a level converter (not shown), and may perform change of amplitude level for a diagnosis device to be compatible with the each unit.

The vehicle gateway 200 changes the vehicle information request received from the access device 300 into a message of a format recognizable by each of the units 110, 120, 130, 141, 142 and 143 in the vehicle network 100, and changes a message received from each of the units 110, 120, 130, 141, 142 and 143 in the vehicle network 100 into vehicle information recognizable by the access device 300. Accordingly, as illustrated in FIG. 3, the VCI 210 does not need to separately include a processor such as a central processing unit (CPU) for processing a message.

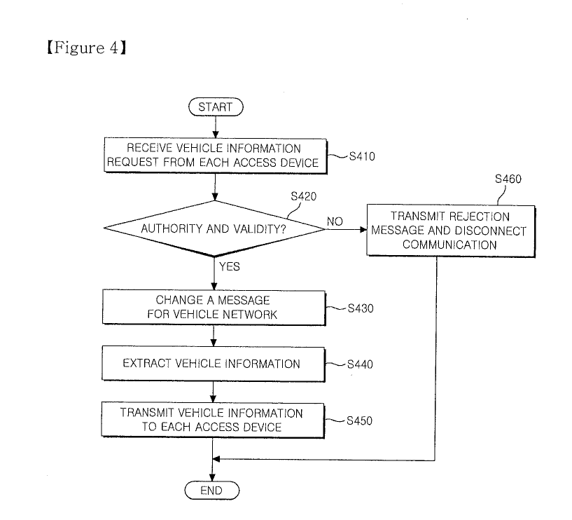

Hereinafter, a process will be described with reference to FIG. 4 in which the apparatus for vehicle network interface or the vehicle gateway receives the vehicle information request from at least one of the access device 300, and extracts and transmits vehicle information corresponding to the vehicle information request.

FIG. 4 is a flowchart illustrating a method for vehicle network interface according to an embodiment of the present invention.

First, the apparatus for vehicle network interface receives the vehicle information request from the access device 300 in step S410.

Specifically, the apparatus for vehicle network interface receives the vehicle information request from the access devices 300, and authenticates communication with the access device 300 requesting the vehicle information to provide a communication.

Subsequently, the apparatus for vehicle network interface checks an access authority and validity to the vehicle information request received from the access device 300 in step S420, and changes the vehicle information request having the access authority and the validity into a message for a vehicle network recognizable by a corresponding unit in the vehicle network 100 in step S430.

Specifically, the apparatus for vehicle network interface checks a device ID, etc included in the vehicle information request received from the access device 300 to search the access device transmitting the vehicle information request, and determines whether a corresponding the access device 300 has an access authority. Furthermore, when a result of the determination shows that the corresponding access device has the access authority, the apparatus for vehicle network interface checks whether the vehicle information request has validity in a link layer. When the vehicle information request has validity in a link layer as a result of the check, the apparatus for vehicle network interface determines whether the vehicle information request has validity in an application layer. When the vehicle information request has validity in the link layer and the application layer, the apparatus for vehicle network interface changes the vehicle information request into a message for a vehicle network.

The apparatus for vehicle network interface extracts vehicle information corresponding to the changed message for the vehicle network from a corresponding unit in the vehicle network 100 and changes the extracted vehicle information into a response for the each access device recognizable by the access device 300 in step S440.

Specifically, The apparatus for vehicle network interface extracts vehicle information corresponding to a message of the access device 300 from the units 110, 120, 130, 141, 142 and 143 in the vehicle network 100, and changes the extracted vehicle information into the response recognizable by the access device 300.

Subsequently, the apparatus for vehicle network interface transmits the changed vehicle information response to each of the requested access device 300 in step S450. Herein, the apparatus for vehicle network interface performs handover between heterogeneous networks according to a need in view of the connection state of the access device 300 before transmission, thereby providing support to maintain a seamless communication state upon transmission and receipt.

While the apparatus for vehicle network interface performs the in the step S420, when there is any one of a case where the vehicle information request does not have the access authority, a case where there is no validity in the link layer and a case where there is no validity in the application layer, the apparatus for vehicle network interface transmits a rejection message to the access device 300 transmitting the vehicle information request and disconnects communication with a corresponding access device 300 in step S460.

The apparatus for vehicle network interface further includes a database (not shown) and prestores the database which is frequently used before receiving the vehicle information request from the access device 300, or defined vehicle information. Alternatively, the database temporarily stores vehicle information before being transmitted to the access device 300, and thus enables the vehicle information to be transmitted in view of a traffic state.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

### INDUSTRIAL APPLICABILITY

The present disclosure provides a vehicle gateway, and an apparatus and a method for vehicle network interface, which enable various access devices and a vehicle network to exchange data.

1. A vehicle gateway, comprising:
a first interface connected to each unit of a vehicle network;
a second interface connected to one or more access devices acquiring vehicle information from the vehicle network; and
a packet processor connecting the first interface to the second interface, and determining a communication system and a communication path to each of the access devices and a process order of the vehicle information acquisition.

2. The vehicle gateway of claim 1, wherein the packet processor comprises:
a queue manager setting the process order;
a packet router allocating the communication path; and
a Media Independent Handover (MIH) handler allocating the communication system.

3. The vehicle gateway of claim 2, wherein the MIH handler supports handover among heterogeneous networks which provides various communication links to each of the access device.

4. The vehicle gateway of claim 1, further comprising a Vehicle Communication Interface (VCI) connecting the first interface to a diagnosis connector of the vehicle to selectively connect the diagnosis connector to a plurality of units connected to the vehicle network.

5. The vehicle gateway of claim 4, wherein the VCI comprises:
a unit interface connected to the vehicle network through the first interface;
a plurality of converters converting a signal to transmit between a diagnosis device connected to the diagnosis connector and each of the units into a format recognizable by the diagnosis device and the each unit; and
a multiplexer selectively connecting the converters to the diagnosis connector.

6. The vehicle gateway of claim 1, wherein the access device comprises at least one of a nomadic device, a roadside device, a vehicle diagnosis device, a Personal Digital Assistant(PDA), a notebook computer, a smart phone and a telematics terminal.

7. The vehicle gateway of claim 1, wherein the vehicle network comprises at least one of Controller Area Network (CAN), Media Oriented Systems Transport (MOST), Local Interconnect Network (LIN), Society of Automotive Engineers (SAE) J1850 and FlexRay.

8. The vehicle gateway of claim 1, wherein the vehicle information comprises at least one of a vehicle speed, a fuel level and a vehicle location.

9. An apparatus for vehicle network interface, comprising;
a vehicle network;
one or more access devices using at least one of wire communication system and wireless communication system, and accessing the vehicle network to request vehicle information and to acquire the vehicle information; and
a vehicle gateway determining a communication system and a communication path between the one or more access devices and the vehicle network and an order of the vehicle information request and an order of the vehicle information acquisition.

10. The apparatus of claim 9, wherein the vehicle gateway supports handover between heterogeneous networks to each of the access devices.

11. The apparatus of claim 9, wherein the vehicle gateway comprises:
an internal interface providing a connection path with each bus in the vehicle network;
an external interface providing a connection path with the one or more access devices; and
a packet processor determining a communication system and a communication path with the one or more access devices, the order of the vehicle information request, and the order of the vehicle information acquisition.

12. The apparatus of claim 9, wherein the vehicle network comprises at least one of Controller Area Network (CAN), Media Oriented Systems Transport (MOST), Local Interconnect Network (LIN), Society of Automotive Engineers (SAE) J1850 and FlexRay.

13. A method for vehicle network interface for connecting a vehicle network to one or more access devices performing wire communication and wireless communication, the method for vehicle network interface comprising:
receiving vehicle information request from each of the access devices;
changing the vehicle information request into a message for the vehicle network;
extracting vehicle information corresponding to the message from the vehicle network to change the extracted vehicle information into a response for the each access device; and
transmitting the response to the each access device receiving the vehicle information request.

14. The method of claim 13, wherein the receiving of the vehicle information request comprises:
receiving the vehicle information request from the each access device; and
authenticating communication with the each access device transmitting the vehicle information request.

15. The method of claim 13, wherein the changing of the vehicle information comprises:
checking whether there is an access authority to the access device transmitting the vehicle information request;
checking validity of the vehicle information request in a link layer when there is the access authority as a result of the check; and
checking validity of the vehicle information request in an application layer when there is the validity as a result of the check.

16. The method of claim 15, further comprising transmitting a rejection message for the vehicle information request to the access device transmitting the vehicle information request when there is no access authority as a result of the check for the access authority, there is no validity as a result of the check in the link layer, or there is no validity as a result of the check in the application layer.

17. The method of claim 13, wherein the changing the vehicle information request comprises:
extracting vehicle information corresponding to the message from the vehicle network; and
changing the extracted vehicle information into vehicle information recognizable by the each access device.

18. The method of claim 13, wherein the transmitting the response to the each access device comprises:
checking whether communication can be performed through the receiving path; and
transmitting the response through the receiving path when the communication can be performed through the receiving path as a result of the check.

19. The method of claim 18, wherein the transmitting of the response further comprises performing handover to a communicable heterogeneous network to transmit the response when the communication cannot be performed through the receiving path as a result of the check.
